(19) United States
(12) Patent Application Publication
(10) Pub. No.: US 2005/0110342 A1
(43) Pub. Date: May 26, 2005

(54) Brake actuator with integral antilock modulator

(76) Inventors: Charles E. Eberling, Wellington, OH (US); Meryln L. Hutchins, Wellington, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/720,584

(22) Filed: Nov. 24, 2003

(51) Int. Cl. B60T 8/42

(52) U.S. Cl. 303/115.1

(57) ABSTRACT

A brake actuator for actuating a brake to decelerate a vehicle includes a housing defining a cavity and an integral modulator. An input passage communicates with a source of pressurized air and the modulator. An outlet passage communicates with the cavity and the modulator. The pressurized air passes from the input passage to the cavity via the modulator and the outlet passage. The modulator modulates the pressurized air passed to the cavity.

### BACKGROUND OF THE INVENTION

This invention relates to the art of brake systems for heavy vehicles and, more particularly, to anti-lock brake systems for vehicles such as truck tractors and tractor-trailer combinations that use brake actuators and antilock modulators.

Antilock brake systems (ABS) have been provided for heavy vehicles, such as truck tractors, trucks, and buses, which have plural axles and one or more wheels supported at the end of each axle. Generally, adjacent each wheel is a brake actuator adapted to engage a brake assembly that is part of or adjacent a wheel to effect the deceleration thereof. Typically, brake actuators are only a portion of an overall antilock brake system, and such brake systems further include an operator interface, such as a foot-actuated pedal, a reservoir containing a quantity of pressurized braking fluid (commonly pressurized air), one or more relay valves and, in antilock braking systems, one or more modulators. It will be appreciated that a considerable amount of brake line is necessary to fluidically interconnect each of these many components of the brake system. It will be further appreciated that these components are mounted on various parts of the vehicle and may be a considerable distance from one another, especially in braking systems on tractor-trailer combinations.

In addition to these mechanical components, antilock brake systems include various electronic control components, including an electronic control unit (ECU) and one or more speed sensors monitoring the rotational speed of the wheels. Furthermore, the modulators typically include an electromechanical interface that uses electrical signals to actuate a mechanical valve.

It will be appreciated that FIGS. 1 and 2, respectively, illustrate a conventional antilock braking system and brake actuator for use on a vehicle, such as a truck tractor. Such antilock braking systems and brake actuators are generally known by those skilled in the art, and the following discussion of FIGS. 1 and 2 is merely provided to establish background environment and terminology for further discussion of the illustrated embodiments of the present invention.

FIG. 1 illustrates a conventional antilock braking system 10 operatively associated with a vehicle (not shown) that has plural axles AX and at least one wheel WL on the axles. Antilock brake system 10 includes a reservoir 12 for storing a quantity of pressurized brake fluid, such as compressed air, which is conveyed to the reservoir by compressor 14 through supply line 16. Relay valves 20 and 22 receive compressed air from the reservoir through primary supply lines 50 and 52, respectively. Relay valve 20 communicates with modulator 30 through secondary supply line 60, and relay valve 22 likewise communicates with modulators 32 and 34 through secondary supply line 62. Modulator 30 selectively outputs either modulated or non-modulated compressed air to service brake actuators 102 through tertiary supply lines 70 and 72. Likewise, modulators 32 and 34 selectively output compressed air to service brake actuators 102 and the service brake portion of spring brake actuators 100. Modulator 32 supplies the actuators, 100 and 102, on one side of the brake system, such as the left side, through tertiary supply lines 80 and 82. Modulator 34 supplies compressed air to the actuators, 100 and 102, on the opposite side of the system, such as at the right side, through tertiary supply lines 84 and 86.

The antilock braking system 10 also includes an electronic control unit 90 for activating the antilock braking function of the system. In response to signals 96 received from wheel speed sensors 94, electronic control unit 90 selectively outputs activation signals 98 to an electromechanical interface 92 of modulators 30, 32, and 34 to effect the modulation, or pulsing, of the compressed air passing therethrough. It will be appreciated that electromechanical interface 92 of the modulators may include any suitable arrangement, such as one or more solenoid and valve assembly, for modulating or pulsing air through the antilock braking system.

Antilock braking systems of the foregoing nature include an operator interface 40 having an actuation pedal 42 and a control valve 44. The control valve opens and closes in proportional response to the displacement of the actuation pedal by the operator. Control supply lines 46 extend between reservoir 12 and control valve 44, and control delivery lines 48 extend between control valve 44 and relay valves 20, 22. As such, compressed air flows from the reservoir to the relay valves upon opening of the control valve by the operator. The presence of pressurized air at the relay valves within the control delivery lines 48 causes a proportional opening of the relay valves, allowing compressed air to flow from the reservoir to the brake actuators and thereby apply the vehicle brakes. It will be appreciated that in other embodiments, the relay valves may be opened and closed by other types of control signals, such as electrical control signals, generated in response to a braking action of the operator.

FIG. 2 illustrates a conventional service brake actuator 102 generally known in the art. Service brake actuator 102 has a housing 110 formed by two housing portions 112 and 114. Housing portion 112 includes an end wall 116 and a side wall 118 extending from the end wall and forming a cavity 120. Housing portion 114 likewise has an end wall 122 and a side wall 124 defining a cavity 126. Flanges 128 and 130 respectively extend from sidewalls 118 and 124, and compressively engage an outer peripheral wall 134 of diaphragm 132. Retaining member 136 extends around the exterior of the housing adjacent flanges 128 and 130, and retains the housing portions in a compressive, air-tight relationship with a peripheral portion of the diaphragm 132. The diaphragm isolates cavities 120 and 126 from one another, and end wall 122 includes a passage 140 in communication with cavity 126.

The service brake actuator also includes a piston assembly 150 positioned within cavity 120. The piston assembly has a push plate or plunger 152, an actuator means 154 (e.g., an actuating rod) extending from the plunger and passing through end wall 116, and a brake-engaging clevis 156 extending from actuator rod 154 outside of housing 110. The brake actuator also includes a biasing member or spring 158 compressively positioned within cavity 120 between end wall 116 and plunger 152, retaining the plunger against diaphragm 132 and urging the actuator rod toward the interior of the brake actuator. Housing 112 also includes mounting hardware 160 for supporting the brake actuator on the vehicle. It will be appreciated that in operation, compressed air selectively enters the brake actuator from the braking system through passage 140, filling cavity 126 and displacing piston assembly 150 such that actuator rod 154 extends from the housing and actuates the brake. Upon release of the pedal by the vehicle operator, the compressed air is vented by the braking system from cavity 126, allowing spring 158 to again urge actuator rod 154 toward the interior of cavity 120.

In use, an operator resides in the vehicle cab and selectively depresses actuation pedal 42 to effect the deceleration of the vehicle. In response to the displacement of the pedal, control valve 44 generates a proportional control signal in the brake system by providing a cooperably associated passage through the control valve such that compressed air can flow between reservoir 12 and relay valves 20, 22 through supply and delivery lines 46, 48. The presence of the control signal delivered to relay valves 20, 22 through control delivery lines 48 causes the proportional opening of the relay valves to permit passage of compressed air from reservoir 12 to modulators 30, 32 and 34, and ultimately to the service brake portion of spring brake actuators 100 and to service brake actuators 102. Compressed air is supplied to relay valve 20 through primary delivery line 50 and proportionally passed through the relay valve to antilock modulator 30 through secondary delivery line 60. Modulator 30 outputs the compressed air to service brake actuators 102 through tertiary delivery lines 70, 72. Compressed air is also supplied to relay valve 22 from reservoir 12 through primary delivery line 52, and is proportionally passed through the relay valve to antilock modulators 32, 34 through secondary delivery line 62. Modulator 32 outputs the compressed air to the actuators, 100 and 102, on one side of the vehicle, such as the left side, through tertiary delivery lines 80, 82, and modulator 34 outputs compressed air to the actuators, 100 and 102, on the other side of the vehicle, such as the right side, through tertiary delivery lines 84, 86.

Each sensor 94 outputs a signal 96, proportional to the rotational speed of its respective wheel, to the electronic control unit 90 which determines if any of the wheels WL have stopped rotating, or are rotating at a significantly different speed than the other wheels. In such case, the electronic control unit outputs antilock activation signals 98 to the electro-mechanical interface 92 of the appropriate antilock modulators. The modulators, in turn, modulate or pulse the compressed air flowing through the tertiary delivery line to the brake actuator thereby reducing or eliminating the locked wheel condition. It will be appreciated that the modulated air is generally present only in the tertiary delivery lines, such as lines 70, 72, 80, 82, 84 and 86. It will be further appreciated that it is along these tertiary delivery lines that the attenuation of the modulated air occurs from which the reduced responsiveness of the antilock braking system results.

The spring brake actuators include a service brake portion and a parking brake portion. The service brake portion functions in the traditional manner to decelerate the vehicle in cooperation with the other service brake actuators. The parking brake portion prevents rotation of the wheels when the vehicle is in a parked condition and may also be applied and act as supplemental service braking under selected circumstances (not illustrated). It will be appreciated that the parking brake portion of the spring brake actuators also includes a parking brake control system for engaging and disengaging the parking brake portion of the spring brakes, and that such a control system is generally conventional and well known in the art so that it is not represented in the drawings or described in further detail herein.

Brake systems of the foregoing nature generally provide a system for reducing the distance required to decelerate a vehicle. However, such systems also have a number of disadvantages that make these systems expensive to manufacture and install, and which preclude the further increase in performance and reduction of stopping distance of vehicles.

One such disadvantage in such antilock braking systems is that one modulator is used to modulate or pulse the pressurized air delivered to two different brake actuators. As such, the modulator is remotely mounted some distance away from each of the two brake actuators, and a separate brake line must be used to carry the pressurized air to each of the brake actuators. The compressibility and inertia of the air in the segment of brake line extending between the modulator and the brake actuator attenuates the braking pulses and leads to a reduced responsiveness of the braking system.

Another disadvantage of braking systems of the foregoing nature is that the modulators typically provide service to two separate brake actuators, and thus the modulators have an increased size to accommodate the air capacity required for a pair of brake actuators. Furthermore, each modulator is installed separately or remotely from the brake actuators to which it provides service. As such, additional costs and installation problems exist in mounting the modulator separately from the brake actuators and installing the brake line extending therebetween. It will be appreciated that in addition to the installation of the segments of brake line extending between the modulator and the two different brake actuators, these segments of line and the air-tight seals existing at both ends of each line must be checked and properly maintained to ensure the reliability of the braking system.

The present invention provides a new and improved apparatus and method which addresses the above-referenced problems.

### BRIEF SUMMARY OF THE INVENTION

In accordance with one embodiment of the present invention, a brake actuator for actuating a brake to decelerate a vehicle includes a housing defining a cavity and an integral modulator. An input passage communicates with a source of pressurized air and the modulator. An outlet passage communicates with the cavity and the modulator. The pressurized air passes from the input passage to the cavity via the modulator and the outlet passage. The modulator modulates the pressurized air passed to the cavity.

In one aspect of the invention, the modulator includes a solenoid that operates in a plurality of modes.

In another aspect of the invention, the modulator includes a supply diaphragm between the input passage and the outlet passage and an exhaust diaphragm between the outlet passage and an exhaust passage. The supply and exhaust diaphragms cooperate to modulate the pressurized air passed to the cavity.

In another aspect of the invention, the modulator includes a first valve, associated with the supply diaphragm, movable to a plurality of positions. The modulator operates in respective ones of a plurality of modes as a function of the position of the first valve. The pressurized air is passed from the input passage to the outlet passage while the modulator is operating in a first one of the modes.

In another aspect of the invention, the modulator includes a second valve, associated with the exhaust diaphragm, movable to a plurality of positions. The modulator operates in the respective ones of the plurality of modes as a function of the respective positions of the first and second valves.

In another aspect of the invention, a first solenoid selectively moves the first valve to the plurality of positions.

In another aspect of the invention, a second solenoid selectively moves the second valve to the plurality of positions.

In another aspect of the invention, the modulator includes an exhaust passage communicating with a face of the exhaust diaphragm. The pressurized air is passed from the outlet passage to the exhaust passage while the modulator is operating in a second one of the modes.

In another aspect of the invention, a speed sensor is associated with a wheel of the vehicle. A comparator determines a comparison of a speed of the vehicle to a speed of the wheel. A modulation controller controls the first and second solenoids as a function of the comparison.

In accordance with another embodiment of the present invention, a brake actuator for a vehicle includes a housing defining a cavity, an input passage communicating with a source of pressurized air, an outlet passage communicating with the cavity, and a means for modulating the pressurized air received via the input passage and communicated to the cavity via the outlet passage.

In accordance with another embodiment of the present invention, a method for actuating a brake to decelerate a vehicle receives a compressed fluid into an input passage of a brake actuator. The compressed fluid is selectively modulated via a modulator integral with the brake actuator. The modulated compressed fluid is passed to a cavity of the actuator via a modulator outlet passage.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 is a schematic illustration of a conventional antilock braking system;

FIG. 2 is a side elevational view, partly in cross-section, of a conventional brake actuator;

FIG. 3 is a schematic illustration of an antilock braking system in accordance with a first embodiment of the present invention;

FIGS. 4-7 are side elevational views, partly in cross-section, of a brake actuator having an integral antilock modulator in accordance with the first embodiment of the present invention;

FIG. 8 is a schematic illustration of an antilock braking system in accordance with a second embodiment of the present invention; and

FIG. 9 is a side elevational view, partly in cross-section, of a brake actuator having an integral antilock modulator in accordance with the second embodiment of the present invention.

### DETAILED DESCRIPTION OF THE INVENTION

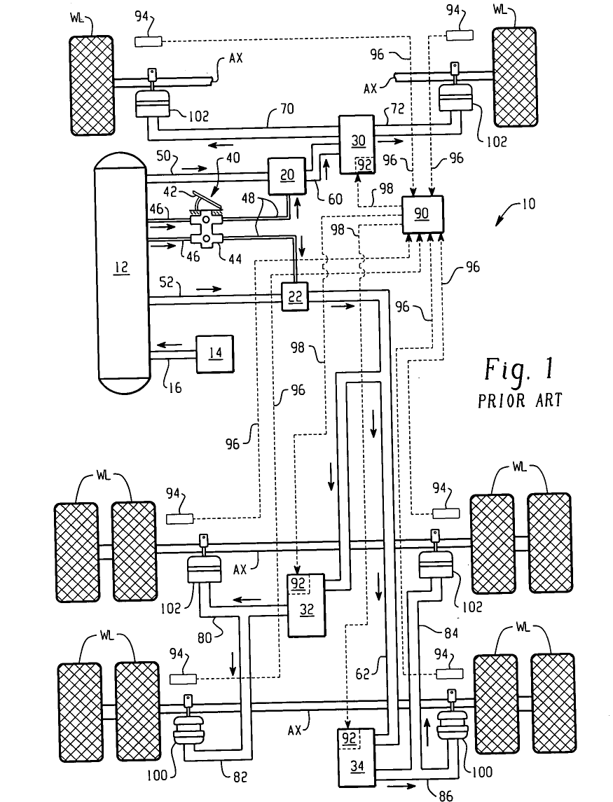

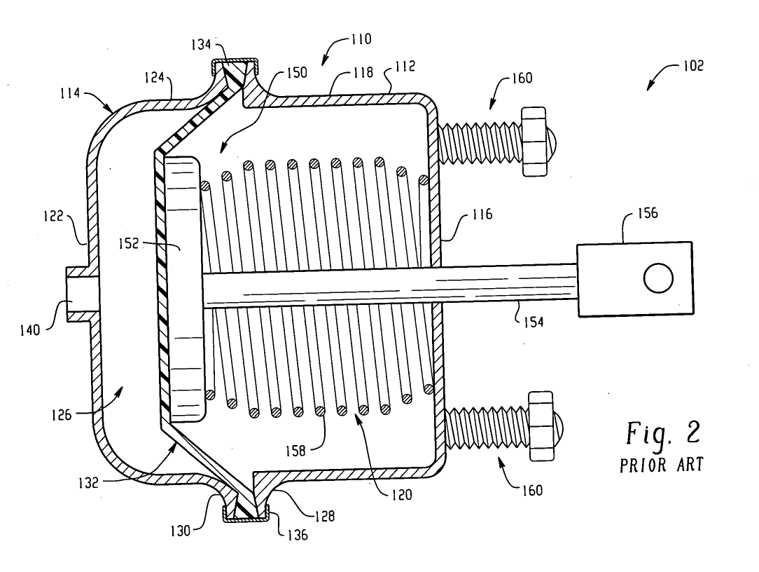

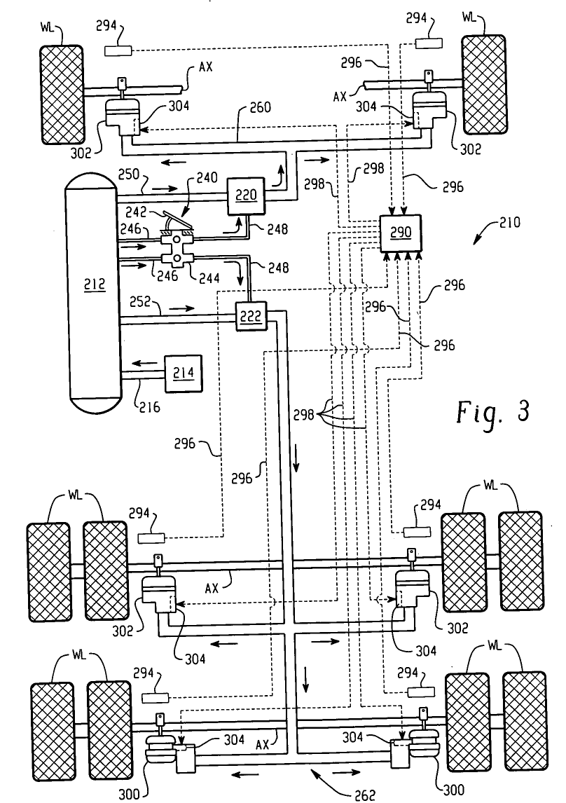

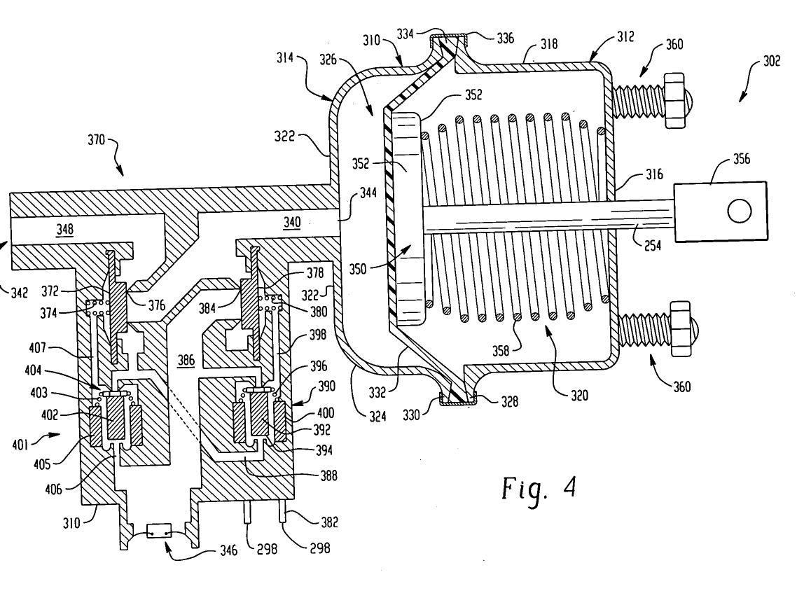

Referring now in greater detail to the FIGS. 3-9, wherein the showings are for the purposes of illustrating various embodiments of the invention only, and not for the purpose of limiting the invention, FIG. 3 schematically illustrates an antilock braking system in accordance with a first embodiment of the invention. FIGS. 4-7 illustrate a brake actuator with an integral antilock modulator in accordance with the first embodiment. Unless otherwise indicated, the items in FIGS. 3-7 correspond to those illustrated and discussed in FIGS. 1 and 2. However, the items in FIGS. 3-7 include reference numerals incremented by 200. That is, the reservoir 12 in FIG. 1 corresponds to item 212 in FIG. 3, and the actuator housing 110 in FIG. 2 corresponds to item 310 in FIG. 4. Items shown and described in one drawing figure, but having no counterpart in one or more of the other figures will be distinctly pointed out and discussed as deemed necessary.

As seen in FIG. 3, pressurized air flows from reservoir 212 to relay valves 220, 222, respectively, through primary delivery lines 250, 252. The relay valves open and close proportionally in response to the control signal delivered through control delivery lines 248 from the control valve 244 of the operator interface 240. As the relay valves open, pressurized air flows therethrough in proportion to the displacement of actuation pedal 242, and the pressurized air is delivered to the service portion of spring brake actuators 300 and to the service brake actuators 302 through secondary delivery lines 260, 262. It will be appreciated that the secondary delivery lines 260, 262 carry the pressurized air directly to the brake actuators 300, 302, and that the antilock modulators 30, 32 and 34 shown in FIG. 1 have no counterpart in FIG. 3. It will be further appreciated that in addition to the elimination of the modulators shown in FIG. 1, the tertiary delivery lines 70, 72, 80, 82, 84 and 86 shown in FIG. 1 have also been eliminated from the embodiment shown in FIG. 3.

Speed sensors 294 in FIG. 3 output a signal 296 to the electronic control unit 290 which determines whether any of the wheels WL have stopped rotating or are rotating at a significantly different speed than the other wheels. As the electromechanical interfaces 92 illustrated in FIG. 1 have no counterpart in FIG. 3, antilock activation signals 298 are output by the electronic control unit 290 directly to the integral electro-mechanical interfaces 304 of the integral antilock brake modulators of brake actuators 300, 302. As such, the antilock modulation or pulsing of the pressurized air occurs at the brake actuator rather than at a remotely located and centralized modulator, such as those illustrated in FIG. 1.

FIG. 4 illustrates a service brake actuator 302 in accordance with the first embodiment of the present invention having a housing 310 formed by two housing portions 312, 314. Housing portion 312 includes an end wall 316 and a side wall 318 extending from the end wall and forming a cavity 320. Housing portion 314 likewise has an end wall 322 and a side wall 324 defining a cavity 326. Flanges 328, 330, respectively, extend from side walls 318, 324, and oppose one another compressively engaging an outer peripheral portion 334 of diaphragm 332. Retaining member 336 extends around the exterior of the housing adjacent flanges 328, 330, and retains the housing portions in a compressive, air-tight relationship with diaphragm 332. The diaphragm seals or isolates cavities 320, 326 from one another, and integral antilock brake modulator 370 extends from end wall 322 and defines an outlet passage 340 in communication with cavity 326 via a delivery passage (port) 344. The modulator 370 also includes an exhaust passage (port) 346. It will be appreciated by those skilled in the art that the antilock brake modulator 370 illustrated in FIGS. 4-7 includes a three-way valve. However, other types of antilock brake modulator assemblies 370 are also contemplated.

Inlet passage 342 is adapted to connect to and form an air-tight seal with one of secondary delivery lines 260 and 262. Pressurized air flows through the secondary delivery lines through inlet passage 342 and into an input passage 348. The delivery passage 344 extends between the passage 340 and cavity 326. Exhaust passage 346 extends through the housing 310 to ambient atmosphere.

The inlet passage 342 communicates through the passage 348 with a first or supply diaphragm 372. The supply diaphragm is normally biased via a spring 374 toward a closed position with valve seat 376. This prevents communication between the supply port 342 and the delivery passage 344. As shown in FIG. 4, when the brake valve is open and provides pressurized air to the inlet passage 348, the closing bias of the spring 374 is overcome and the supply diaphragm is moved away from the valve seat 376 to provide pressurized air to the delivery passage 344. This allows application of the brakes during what is referred to as normal service braking for decelerating the vehicle.

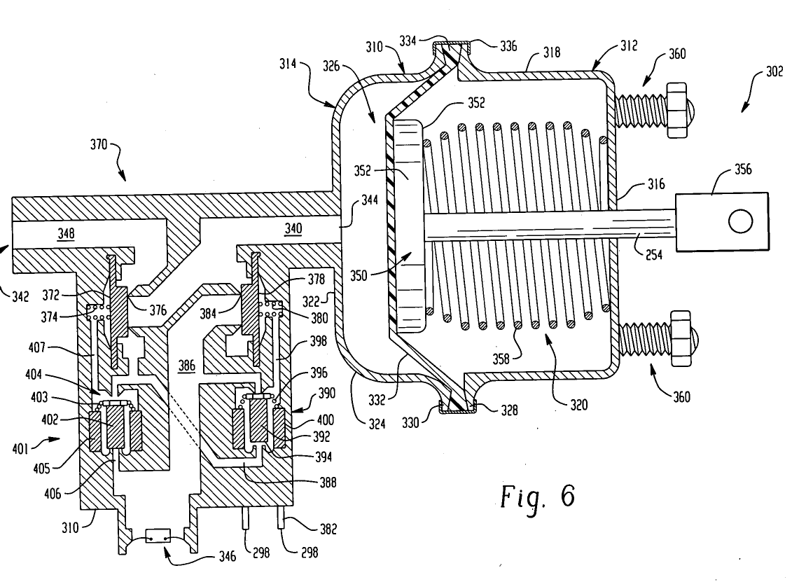

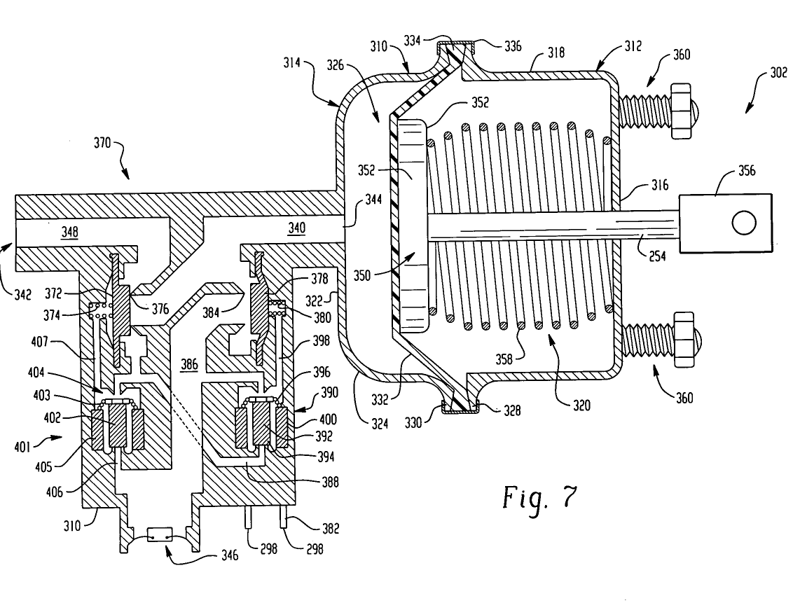

During normal service braking, pressurized air flows from the reservoir 212 through the primary delivery lines 250, 252 and into the secondary delivery lines 260, 262 as the relay valves 220, 222 are opened in proportion to the signal received from the operator interface. The pressurized air flows through the secondary delivery lines 260, 262 and into the inlet passage 342 and the passage 348. The pressurized air then passes to the delivery passage 344 and the cavity 326 to displace the piston assembly 350 and move the actuator rod 354 out of the housing 310 to actuate the brakes and thereby decelerate the vehicle. Throughout the braking operation, each wheel speed sensor 294 provides a signal 296 to the electronic control unit 290 that is proportional to the speed of each respective wheel WL. If necessary, the electronic control unit 290 outputs an antilock brake actuation signal 298 to the input terminal 382 of the appropriate brake actuators initiating the antilock braking operation of the braking system, which is discussed in more detail below with reference to FIGS. 6 and 7.

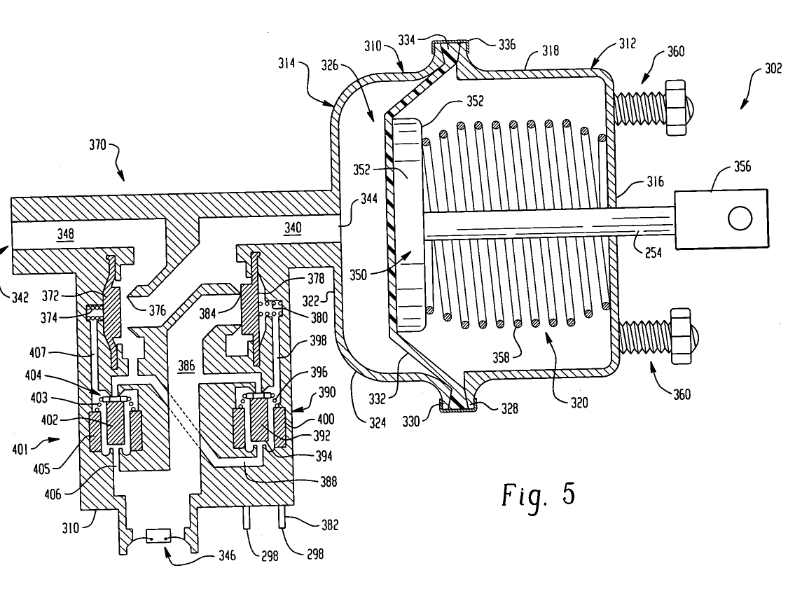

In addition, an exhaust diaphragm 378 is urged by spring 380 toward a closed position against valve seat 384. This prevents communication of the pressurized air that enters the modulator past valve seat 376 to the delivery passage 344 with an exhaust passage 386 that leads to the exhaust passage 346. Thus as shown in FIGS. 4 and 5, the exhaust diaphragm is disposed in a closed position. As will be recognized, when the supply diaphragm is moved away from the valve seat 376 during a service brake application, pressurized air is also provided through pilot passage 388 to a first exhaust solenoid valve 390. Particularly, the passage 388 communicates with a pusher member (valve) 392, particularly a first end 394, of the solenoid valve. As shown in FIGS. 4 and 5, the pusher member 392 is biased or urged by spring 396 toward a normally open position allowing communication between passage 388 and passage 398 that communicates with the exhaust diaphragm 378. Alternatively, when coil 400 of the solenoid valve is energized, the pusher member is urged toward a closed position preventing communication between flow passages 388, 398. When the brakes are applied during normal service application, pressurized air from pilot passage 388 communicates through the first solenoid 390, through the passage 398 and, along with the spring 380, urges the exhaust diaphragm toward a closed position. This provides a pressure assist to urge the diaphragm valve toward a closed position during normal service brake application.

As will be further recognized from FIGS. 3 and 4, passage 388 also communicates with a second or supply solenoid valve assembly 401 and supply passage 348. A pusher member (valve) 402 of the second solenoid is urged by spring 403 toward a normally closed position against valve seat 404. That is, the flow passage 388 and supply passage 348 cannot communicate with the opposite face of the diaphragm 372 unless the coil 405 moves the pusher member against the force imposed by the spring. Instead, a pilot passage 406 connects the supply diaphragm with the exhaust port through the second solenoid valve assembly 401, and through passage 407.

Although not particularly shown, it will be understood that a rapid exhaust is provided when the exhaust diaphragm 378 is urged away from its seat 384 and the brake port 344 is in communication with the exhaust port 346. In that arrangement, the brake actuators are quickly released as the pressure exits the brake chamber through the exhaust passage 386 to port 346.

FIGS. 6 and 7 represent the same modulator valve structure as referenced with respect to FIGS. 3 and 4, and will be briefly described herein to provide an indication of the ABS operation. As indicated above, the first or exhaust solenoid valve 390 is urged toward a normally open position. The second or supply solenoid valve 401 is urged toward a normally closed position. In response to an antilock activation signal 298 received through input terminal 382, the coils 400, 405, associated with the first and second solenoid valve assemblies 390, 401, respectively, are selectively energized to urge the respective pusher members 392, 402 to overcome the bias of the springs. Thus as shown in FIG. 6, the second solenoid valve 401 is energized. This provides communication between pilot passage 388 and passage 348 and passage 407, moving the diaphragm 372 to a closed position so that a constant air pressure is provided to the delivery port 344.

FIG. 7 illustrates the energization of the first solenoid assembly (while the second solenoid valve assembly also remains energized) which closes off communication between passage 388 and passage 398. In this manner, the exhaust diaphragm 378 is urged away from its valve seat 384 thus allowing the delivery port 344 to communicate with the exhaust port 346. The actuation of the brakes on the vehicle are modulated or pulsed to provide controlled braking of the wheels WL.

It will be appreciated that the modulated or pulsed air directly enters the cavity through the delivery passage rather than having to first flow from a remotely located modulator through tertiary delivery lines to the actuator. As such, the reduced responsiveness of the system due to the attenuation of the modulated or pulsed air flowing through the tertiary delivery lines encountered in prior art arrangements is eliminated.

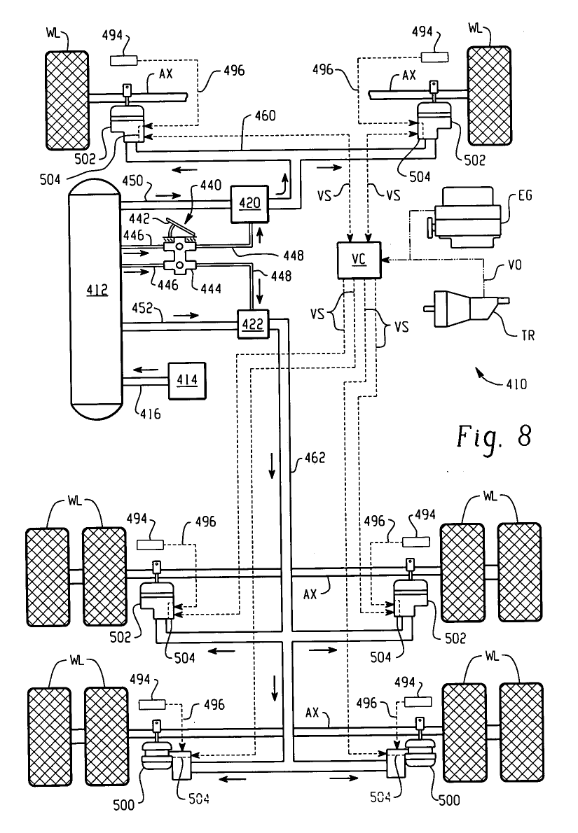

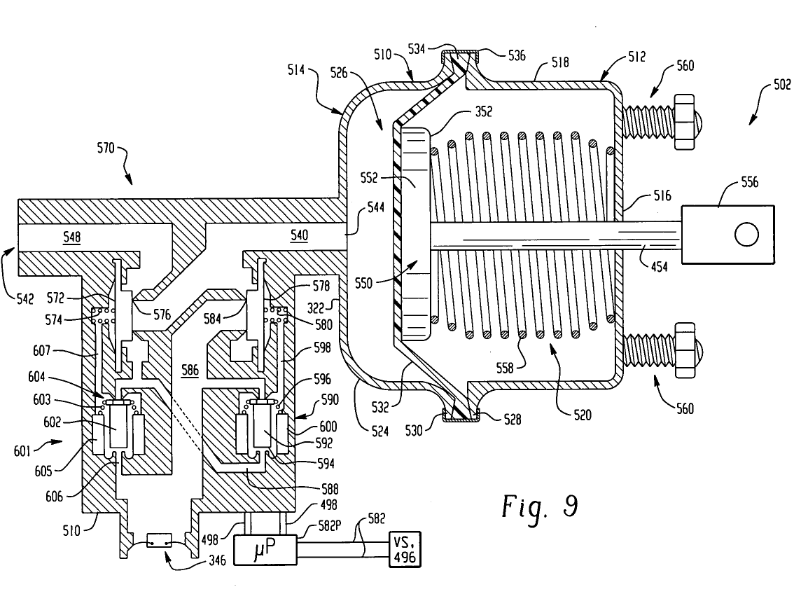

FIG. 8 illustrates an alternate embodiment of the antilock braking system shown in FIG. 3, and FIG. 9 illustrates an alternate embodiment of the brake actuator having an integral antilock modulator shown in FIG. 4. Unless otherwise indicated, the items in FIGS. 8 and 9 correspond to those illustrated in and discussed with respect to FIGS. 3-7. However, the items in FIGS. 8 and 9 include reference numerals incremented by 200. For example, the reservoir 212 in FIG. 3 corresponds to item 412 in FIG. 8, and the actuator housing 310 in FIG. 4 corresponds to item 510 in FIG. 9. Items shown and described in one drawing figure, but having no counterpart in one or more of the other figures will be distinctly pointed out and discussed as deemed necessary.

As discussed with regard to FIG. 3, modulators 30, 32 and 34, and tertiary delivery lines 70, 72, 80, 82, 84 and 86 have no counterpart in antilock braking system 410 shown in FIG. 8. Furthermore, the electronic control unit 90 illustrated in both FIGS. 1 and 3 has no counterpart in FIG. 8 and, as such, antilock activation signals 98 likewise have no counterpart in FIG. 8. Rather, FIG. 8 illustrates an antilock braking system 410 operatively associated with a vehicle having an engine EG and a transmission TR. The vehicle also includes a vehicle control module VC that receives vehicle output signals VO from the engine and the transmission. It will be appreciated, that the vehicle output signals include a signal indicating the overall speed of the vehicle, and that the vehicle control module VC communicates a vehicle speed signal VS to the integral electromechanical interface 504 of each brake actuator 500, 502. Additionally, wheel speed sensors 494 output signals 496 proportional to the rotational speed of each respective wheel, and the signals 496 are also communicated to the electromechanical interface 504 of each respective brake actuator.

As is shown in FIG. 9, brake actuator 502 includes a housing 510 having a first housing portion 512 and a second housing portion 514. The actuator includes a diaphragm 532 and a piston assembly 550 assembled in association with the two housing portions as discussed above. The brake actuator 502 also includes an integral antilock brake modulator 570 extending from housing portion 514. The modulator 570 has a passage 540 as discussed hereinbefore. The modulator 570 further includes a modulation controller 582p having a signal comparator, such as a micro-processor. Input terminals 582 are in electrical communication with the modulation controller 582p. The input terminals 582 receive a vehicle speed signal VS and a speed sensor output signal 496. The micro-processor compares the signals VS and 496, and selectively outputs antilock brake activation signals 498 to the solenoid valves 590, 601 when a determination is made that the wheel has stopped rotating or is rotating at a different relative speed than another wheel of the vehicle as indicated by vehicle speed signal VS. In response, the solenoid is energized and de-energized in rapid succession to modulate or pulse the pressurized air entering the brake actuator and thereby eliminate the locked wheel condition. As discussed hereinbefore with regard to FIG. 4, modulator 570 of FIG. 9 typically includes a pair of solenoid valve assemblies.

While the invention has been described with reference to the preferred embodiments and considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of the appended claims or the equivalents thereof.

1. A brake actuator for actuating a brake to decelerate a vehicle, the brake actuator comprising:
a housing defining a cavity;
an integral modulator;
an input passage communicating with a source of pressurized air and the modulator; and
an outlet passage communicating with the cavity and the modulator, the pressurized air passing from the input passage to the cavity via the modulator and the outlet passage, and the modulator modulating the pressurized air passed to the cavity.

2. The brake actuator as set forth in claim 1, wherein the modulator includes:
a solenoid that operates in a plurality of modes.

3. The brake actuator as set forth in claim 1, wherein the modulator includes:
a supply diaphragm between the input passage and the outlet passage; and
an exhaust diaphragm between the outlet passage and an exhaust passage, the supply and exhaust diaphragms cooperating to modulate the pressurized air passed to the cavity.

4. The brake actuator as set forth in claim 3, wherein the modulator includes:
a first valve, associated with the supply diaphragm, movable to a plurality of positions, the modulator operating in respective ones of a plurality of modes as a function of the position of the first valve, the pressurized air being passed from the input passage to the outlet passage while the modulator is operating in a first one of the modes.

5. The brake actuator as set forth in claim 4, wherein the modulator includes:
a second valve, associated with the exhaust diaphragm, movable to a plurality of positions, the modulator operating in the respective ones of the plurality of modes as a function of the respective positions of the first and second valves.

6. The brake actuator as set forth in claim 5, further including:
a first solenoid for selectively moving the first valve to the plurality of positions.

7. The brake actuator as set forth in claim 6, further including:
a second solenoid for selectively moving the second valve to the plurality of positions.

8. The brake actuator as set forth in claim 5, wherein the modulator includes:
an exhaust passage communicating with a face of the exhaust diaphragm, the pressurized air being passed from the outlet passage to the exhaust passage while the modulator is operating in a second one of the modes.

9. The brake actuator as set forth in claim 5, further including:
a speed sensor associated with a wheel of the vehicle;
a comparator for determining a comparison of a speed of the vehicle to a speed of the wheel; and
a modulation controller for controlling the first and second solenoids as a function of the comparison.

10. A brake actuator for a vehicle, the brake actuator comprising:
a housing defining a cavity;
an input passage communicating with a source of pressurized air;
an outlet passage communicating with the cavity; and
means for modulating the pressurized air received via the input passage and communicated to the cavity via the outlet passage.

11. The brake actuator as set forth in claim 10, wherein the means for modulating is included in the housing.

12. The brake actuator as set forth in claim 10, wherein the means for modulating includes:
a supply diaphragm for controlling a flow of the pressurized air between the input passage and the outlet passage;
a first pusher member, associated with the supply diaphragm, movable to a plurality of positions; and
a first solenoid for controlling the position of the first pusher member, the pressurized air being passed from the input passage to the outlet passage when the first pusher member is in a first of the positions.

13. The brake actuator as set forth in claim 12, wherein the means for modulating further includes:
an exhaust diaphragm for controlling a flow of the pressurized air between the outlet passage and an exhaust passage, the supply and exhaust diaphragms cooperating to modulate the pressurized air passed to the cavity;
a second pusher member, associated with the exhaust diaphragm, movable to a plurality of positions; and
a second solenoid for controlling the position of the second pusher member, the pressurized air being passed from the outlet passage to the exhaust passage when the second pusher member is in a first of the positions.

14. The brake actuator as set forth in claim 13, further including:
a control terminal for receiving antilock braking signals selectively causing the first and second pusher members to move between the plurality of positions.

15. The brake actuator as set forth in claim 13, wherein the supply and exhaust diaphragms cooperate to modulate the pressurized air passed to the cavity.

16. A method for actuating a brake to decelerate a vehicle, the method comprising:
receiving a compressed fluid into an input passage of a brake actuator;
selectively modulating the compressed fluid via a modulator integral with the brake actuator; and
passing the modulated compressed fluid to a cavity of the actuator via a modulator outlet passage.

17. The method for actuating a brake to decelerate a vehicle as set forth in claim 16, further including:
moving a first valve, which is associated with a supply diaphragm between the input passage and the outlet passage, between a plurality of positions, the modulator operating in respective modes as a function of the position of the first valve; and
if the modulator is in a first of the modes, passing the compressed fluid from the input passage to the outlet passage.

18. The method for actuating a brake to decelerate a vehicle as set forth in claim 17, further including:
moving a second valve, which is associated with an exhaust diaphragm, between a plurality of positions, the modulator operating in one of the modes as a function of the positions of the first and second valves.

19. The method for actuating a brake to decelerate a vehicle as set forth in claim 18, further including:
transmitting a first control signal to a first solenoid for controlling the first valve; and
transmitting a second control signal to a second solenoid for controlling the second valve.

20. The method for actuating a brake to decelerate a vehicle as set forth in claim 19, wherein the transmitting steps include:
determining whether antilock braking signals are received at a control terminal; and
transmitting the control signals to the first and second solenoids as a function of whether the antilock braking signals are received at a control terminal.
